(19) United States
(12) Patent Application Publication
(10) Pub. No.: US 2024/0191724 A1
(43) Pub. Date: Jun. 13, 2024

(54) Intake Chamber and Suction Jet Pump

(71) Applicant: Bayerische Motoren Werke Aktiengesellschaft, Muenchen (DE)

(72) Inventors: Christoph LAUMER, Woerth/Donau (DE); Raul Ramos ALONSO, Schechen (DE); Benjamin SCHIMPF, Winkelhaid (DE); Christian TREML, Muenchen (DE)

(21) Appl. No.: 18/280,301

(22) PCT Filed: Mar. 8, 2022
(86) PCT No.: PCT/EP2022/055906

§ 371 Date: Feb. 13, 2024

(30) Foreign Application Priority Data
Mar. 8, 2021 (DE) 10 2021 105 492.3

(51) Int. Cl. F04F 5/10; F04F 5/46

(52) U.S. Cl. CPC F04F 5/10; F04F 5/46

(57) ABSTRACT

An intake chamber (10) for an operating medium pump for sucking up operating medium stored in an operating medium tank of a motor vehicle, comprising a housing (20) in which at least two inlet openings (31, 32) for admitting operating medium to a connection (60) formed in the top side of the housing (20) are formed, wherein a deflecting wall (51, 52) is arranged in the housing (20) be-tween each inlet opening (31, 32) and the connection (60). Undercuts (81, 82) are formed on the inside of the inlet openings (31, 32). A suction jet pump or operating medium pump with at least one such intake chamber 10 is also disclosed.

### BACKGROUND AND SUMMARY OF THE INVENTION

The present subject matter relates to an intake chamber for an operating medium pump for sucking in operating medium stored in an operating medium vessel of a motor vehicle. The present subject matter also relates to a suction jet pump or operating medium pump having such an intake chamber.

Operating medium vessels are typically used to store liquid operating medium such as fuel, water or additives for exhaust-gas aftertreatment in a motor vehicle. Such operating medium vessels are typically constructed such that they adapt to installation spaces in a motor vehicle, in order to utilize these installation spaces in an ideal manner. This can also mean that there are regions in an operating medium vessel which are subjected to active suction removal by an operating medium pump for the purpose of better usability, in order to convey the operating medium to a collecting point such as a surge tank. As a result, a complete or at least largely complete withdrawal of operating medium can be ensured even in the case of low fill levels.

Such operating medium pumps may be embodied, for example, as a suction jet pump. They may for example have intake chambers which serve to receive the operating medium at a determined location within the operating medium vessel.

It is a preferred object of the present subject matter to reduce or eliminate at least one disadvantage of a previously known solution or to propose an alternative solution. It is a preferred object of the present subject matter to provide an intake chamber for an operating medium pump, said intake chamber being better and/or easier to handle compared with the prior art. Further preferred objects may result from the advantageous effects of the present subject matter. The objects are achieved by the subject matter of the independent patent claims. The dependent claims represent preferred refinements.

The present subject matter relates to an intake chamber for an operating medium pump for sucking in operating medium stored in an operating medium vessel of a motor vehicle, comprising (i) a housing, the lower side of which is configured to abut against a bottom of the operating medium vessel and in the upper side of which at least one connector for a line of the operating medium pump is formed. At least a first inlet opening and a second inlet opening for the inlet of operating medium to the connector are expediently formed laterally in the housing. A deflecting wall is expediently arranged between each inlet opening and each connector in the housing.

An undercut is expediently formed on the inside of at least one inlet opening. In particular, it may be arranged directly on the inside of the inlet opening or directly adjoining the inlet opening.

Using an intake chamber, suction removal can be effected from the upper side, as a result of which the installation space requirement in a horizontal direction is reduced considerably in comparison with examples having a laterally or horizontally arranged connector. As a result of the two inlet openings, operating medium can flow laterally into the housing in a simple manner, in order to subsequently be removed by suction via the connector. The deflecting walls ensure that the operating medium is conducted toward the connector and flowing-out of the operating medium, for example in the case of sloshing movements, is at least partially prevented.

An undercut defines a space which is not directly impinged on by operating medium flowing into the inlet opening. When the operating medium impinges on this space, a vortex is consequently formed. This generates a negative pressure and thus a suction which sucks further operating medium into the intake chamber. This is maintained both by operating medium being removed by suction via the connector and by operating medium flowing out via the other inlet openings. In this case, this flowing-out is inhibited insofar as a space under the connector is filled with operating medium, in order to enable efficient suction removal, but a flowing-out action for maintaining the vortex remains possible.

An intake chamber is a chamber which serves for sucking in operating medium in an operating medium vessel by way of an operating medium pump. It receives operating medium at a determined location. In this case, the lower side typically abuts against the bottom of the operating medium vessel, wherein the abutment may be full or only partial. Surrounding operating medium can flow in through an inlet opening, in order to pass to the connector. The deflecting walls may be in the form of vertical walls and direct the flow of the operating medium.

In particular, an undercut may be formed on the inside of some of the inlet openings or all of the inlet openings. This makes it possible for the functionality of the vortex to be implemented at a plurality of or all of the inlet openings.

In particular, an undercut, some or all of the undercuts may be formed by a projection in the housing, said projection expediently directly adjoining the inlet opening. The projection may be formed at least partially, directly adjoining the inlet opening, in an areal manner and/or so as to lie in a plane. It may be attached to the rest of the housing for example by a rounded portion.

A projection, some or all of the projections may be oriented in a plane with the inlet opening. As a result, operating medium flowing in transversely with respect to the inlet opening immediately encounters a space which widens as seen in a direction of approximately 90°. This promotes the formation of a vortex.

A projection, some or all of the projections may preferably assume an angle of at least 45° and/or an angle of at most 90° with respect to a directly adjoining portion of the housing. This permits the formation of a suitable space in which vortices can form.

According to one example, at least a third inlet opening for the inlet of operating medium to the connector is formed laterally in the housing. According to one example, at least a fourth inlet opening for the inlet of operating medium to the connector is formed laterally in the housing. In this way, the number of inlet openings can be increased and operating medium can flow to the connector from more sides.

The inlet openings may be formed in an elongate manner on side surfaces of the housing. This allows operating medium to flow in in a simple manner. In particular, the inlet openings reach as far as the bottom of the operating medium vessel when the intake chamber is mounted thereon.

The inlet openings may have identical angular spacings to respective peripherally adjacent inlet openings. This permits a uniform example. However, other examples are also possible.

The inlet openings and/or the deflecting walls may be invariant in relation to rotations by angles which are 360° divided by the number of inlet openings or an integer multiple thereof. This permits a corresponding symmetry and thus a simple production of the intake chamber.

The deflecting walls and/or other constituent parts of the housing may form a respective channel from the inlet openings toward the connector, said channel having, at least along a portion, a cross section which decreases toward the connector. As a result, the flow resistance at the outside can be kept small, but as the distance toward the connector decreases the fluid flow can be directed at the connector to an increasing extent.

A cross section can be seen at least approximately transversely with respect to a flow direction of the inflowing operating medium.

A further connector may be formed in the upper side of the housing and may be arranged directly adjacent to the connector. This can mean that there is only a small spacing between the connector and the further connector, in comparison to the total extent of the housing. As a result, not only can suction removal be performed but a motive jet can also be fed in, which makes it possible to be able to implement a suction functionality by generation of negative pressure within the intake chamber.

A motive nozzle and a mixing chamber may be arranged in the housing, wherein the motive nozzle may be directed at the mixing chamber and may be connected on the input side to the further connector, and the mixing chamber may be connected on the output side to the connector and may comprise an opening to the interior of the housing. Using a motive nozzle and a mixing chamber, it is thus possible to implement a suction function within the intake chamber using a motive jet, wherein the motive jet typically enters the intake chamber through the further connector, passes into the mixing chamber via the motive nozzle and exits the intake chamber again via the connector. In this case, a negative pressure is generated in the intake chamber and can actively suck in surrounding operating medium.

The motive nozzle and the mixing chamber may be arranged in a module which can be removed from the housing. This makes it possible to achieve a modular construction, wherein it is for example possible to use an intake chamber both with and without such a module. In the event of a fault, it may suffice to exchange the module.

According to one example, a flow control structure is arranged at the inlet openings, at the outside in relation to the respective deflecting wall. In particular, each inlet opening may be assigned a respective flow control structure. The flow control structure may extend along a respective line. This may be straight or curved.

Using a flow control structure, it is possible to control the inflow and outflow of operating medium, i.e. it is for example possible to ensure that operating medium flows into the intake chamber more easily than it flows out of said intake chamber.

The flow control structure or some of the flow control structures or all of the flow control structures may comprise a plurality of first flow resistance elements and a plurality of second flow resistance elements, which are arranged in an alternating manner along the respective line. The first flow resistance elements may be of tapered form in an outflow direction and the second flow resistance elements may be of droplet-like form in cross section, wherein a tip of the droplet points toward the interior of the housing. In this way, it is advantageously possible for operating medium to be able to flow in with the lowest possible flow resistance and to be subjected to a considerably higher flow resistance if it were to flow out of the intake chamber again.

In this case, the line may be defined separately for each inlet opening. By way of example, it may extend at the outer edge of the housing or extend inwardly offset to some extent relative thereto or parallel or at a predefined angle relative thereto.

The first flow resistance elements may be of triangular or arrowhead-like example in cross section, which can be seen transversely with respect to a vertical axis. In this case, a tip may point outward. The droplet-like configuration of the second flow resistance elements may be designed such that a bulbous region of the respective droplet points outward, such that the flow resistance is also increased as a result. The described example has proven to be particularly advantageous since it hardly impedes the inlet of operating medium but considerably impedes the flowing out again.

As an alternative, the flow control structures may be embodied, for example, as an interrupted wall along the respective line. This enables a simpler example. The combination of the examples is also possible.

The connector may be in the form of an opening through which a line is plugged. Equally, the further connector may be in the form of an opening through which a line is plugged. This enables a simple example.

The connector may be in the form of a line protruding into the housing. Equally, the further connector may be in the form of a line protruding into the housing. It is for example possible for a line of an operating medium pump to be connected directly to such a line.

The lower side of the housing may lie in a plane. This permits an abutment against a planar bottom of an operating medium vessel. However, the lower side may also be structured in a similar manner, in a complementary manner, to such a bottom, in order to better adapt to a structured bottom.

Advantageously, the intake chamber is completely closed on the upper side outside of the connector and/or of the further connector. This prevents operating medium located in the intake chamber from escaping on the upper side. This makes the suction removal of operating medium easier and maintains a throughflow through the intake chamber.

The present subject matter also relates to a suction jet pump or operating medium pump, comprising (i) at least one electrical pump and (ii) at least one intake chamber as described herein, wherein the connector or further connector of the intake chamber is fluidically connected to the electrical pump. This makes it possible for the intake chamber to be used in an ideal manner for a suction jet pump. In particular, an operating medium pump may be a suction jet pump, or a suction jet pump may be an operating medium pump.

A preferred operating medium is fuel. It is also conceivable for the present subject matter to be used to store other liquid (for example water or an aqueous solution) in a motor vehicle. Therefore, even though an operating medium vessel, an operating medium pump and the like are discussed here, the terms fuel vessel and fuel pump are also intended to be disclosed.

The operating medium vessel may form a storage volume for storing the operating medium. The operating medium vessel thus forms the substantially fluid-tight outer envelope of the storage volume and delimits the storage volume from the installation space. In the case of fuel vessels, reference is made, for example, to the bladder. In the case of steel vessels, the operating medium vessel may be formed, for example, from two metal shells. Advantageously, the operating medium vessel may have a saddle shape comprising a main chamber and a secondary chamber which are connected to one another via a connecting region. An operating medium pump may be a passive pump, a suction jet pump. Suction jet pumps are known per se.

In other words, the infeed of the fuel or of the operating medium into a suction-removal point can be promoted or simplified by providing a plurality of inlets. A suction point may be embodied as an active or passive suction point. Mirrored variants by tool inserts or separation of upper part (cover) and lower part (labyrinth) may likewise be implemented. Here, targeted introduction of vortices and counter-vortices for minimizing pressure losses is likewise achieved. Transverse connections between the individual arms or blades are conceivable. By way of example, it is possible for a mirror-image arrangement to be able to be produced.

### BRIEF DESCRIPTION OF THE DRAWINGS

FIG. 1 shows a perspective illustration of an intake chamber,

FIG. 2 shows a schematic view of the intake chamber from FIG. 1,

FIG. 3 shows a schematic view of a further intake chamber,

FIG. 4 shows a schematic view of a further intake chamber,

FIG. 5 shows a schematic view of a further intake chamber,

FIG. 6 shows a schematic view of yet a further intake chamber, and

FIG. 7 shows a module comprising motive nozzle and mixing chamber.

### DETAILED DESCRIPTION

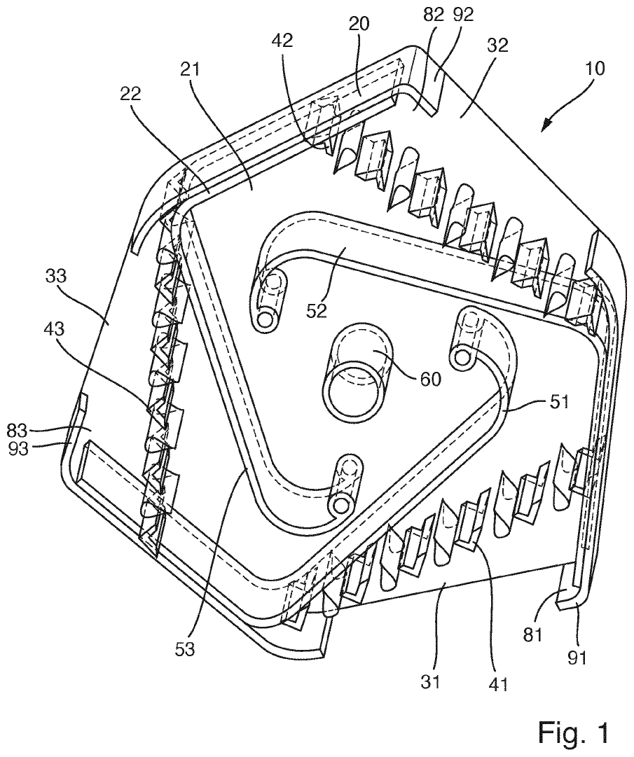

FIG. 1 shows, in purely schematic form, a perspective view of an intake chamber 10 according to one example from below. The intake chamber 10 comprises a housing 20 which defines the outline of the intake chamber 10.

A first inlet opening 31, a second inlet opening 32 and a third inlet opening 33 are formed in the housing 20. These each point to the side and enable a lateral inlet of surrounding operating medium.

The housing 20 comprises an upper side 21 and a lower side 22. In the present case, the lower side 22 is of planar form, specifically along a path which is divided into three portions on account of the inlet openings 31, 32, 33. The lower side 22 can abut against a flat bottom of an operating medium vessel, such that merely the inlet openings 31, 32, 33 are open toward the side.

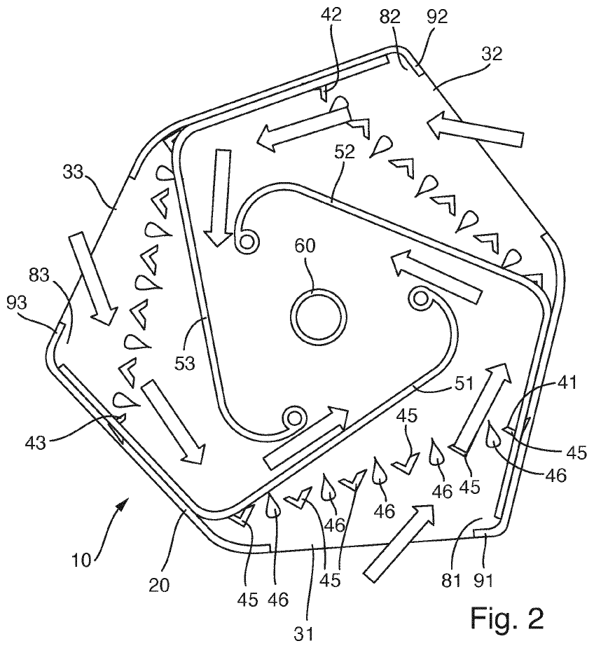

A respective flow control structure 41, 42, 43 is arranged in each case on the inside in relation to each of the inlet openings 31, 32, 33. Said flow control structure will be described in more detail further below with reference to FIG. 2. Arranged even further on the inside is a respective deflecting wall 51, 52, 53. The deflecting walls 51, 52, 53 extend downward from the upper side 21 of the housing 20 toward the bottom (not illustrated) of an operating medium vessel and effect sealing downward at the respective point.

The example shown makes it possible for operating medium, which is located in an operating medium vessel, to enter through each of the inlet openings 31, 32, 33. It then passes through the respective flow control structure 41, 42, 43 and enters a continuously narrowing channel between housing 20 and respective deflecting wall 51, 52, 53. Lastly, the operating medium passes toward the center of the housing 20. Located there is a connector 60 which is arranged in the upper side 21 of the housing 20. In the present case, the connector 60 is embodied as a hole, wherein a line can be plugged into this hole and can thus generate, by application of a corresponding negative pressure, a negative pressure within the intake chamber 10 by which the operating medium located in the intake chamber 10 is removed upward by suction. At the point at which the intake chamber 10 is located, it is thus possible for operating medium to be removed by suction in a particularly advantageous manner.

Respective undercuts 81, 82, 83 are arranged directly on the inside of the inlet opening 31, 32, 33. These are formed by respective projections 91, 92, 93 which project from adjoining portions of the housing 20 in the direction of the respective inlet opening 31, 32, 33. As a result, a vortex forms on the inside of the respective inlet opening 31, 32, 33 when operating medium flows in, as a result of which a suction effect is produced which sucks in further operating medium.

As a result, it is possible, in the case of very low fill levels at which only individual waves flow through the operating medium vessel on account of sloshing movements, to achieve a particularly good suction of the operating medium. The operating medium can enter at an inlet opening 31, 32, 33 and form the vortex. It can be removed by suction, but at the same time can in some cases also exit through the other inlet openings 31, 32, 33 again, as a result of which accumulation in the intake chamber 10 is prevented and the action of the vortex is maintained.

On the upper side, the intake chamber 10 is completely closed outside of the connector 60. The described functionalities of the sucking in of operating medium and the throughflow, including vortex formation, can advantageously develop as a result and are not impaired as a result of operating medium exiting on the upper side 21.

FIG. 2 shows, in purely schematic form, a view of the intake chamber 10 from below. In this case, the elements already described with reference to FIG. 1 can be seen. Arrows are also depicted which indicate the typical flow when operating medium enters.

In addition, the first flow control structure 41 is illustrated in a more detailed form in FIG. 2. The first flow control structure 41 comprises first flow resistance elements 45 and second flow resistance elements 46, which are arranged along a line. The line thus extends in a slightly inclined manner with respect to the extent of the first inlet opening 31. In this case, the first flow resistance elements 45 have a cross section which is of tapered form in the outflow direction, that is to say in the direction opposite to the depicted arrows. In the present case, they are of arrowhead-like example. The second flow resistance elements 46 are of droplet-like example in cross section, wherein a respective tip points toward the interior of the housing 20.

By way of this example, the entry of operating medium is hardly impeded, but the exit of operating medium is impeded to a significantly greater degree. This is due to the combination of tapering cross section of the first flow resistance elements 45 and the cleverly arranged droplet shape of the second flow resistance elements 46. This makes it possible to prevent operating medium already located in the intake chamber 10 from spilling out in substantial parts again when, for example, acceleration forces are acting.

As can be seen in FIG. 2, the inlet openings 31, 32, 33 are arranged with identical angular relationships to one another. They are rotationally symmetrical in relation to an angle of 120°. This corresponds to an example with three inlet openings, wherein it should be noted that different numbers of inlet openings may also be used and different angular relationships may also be used.

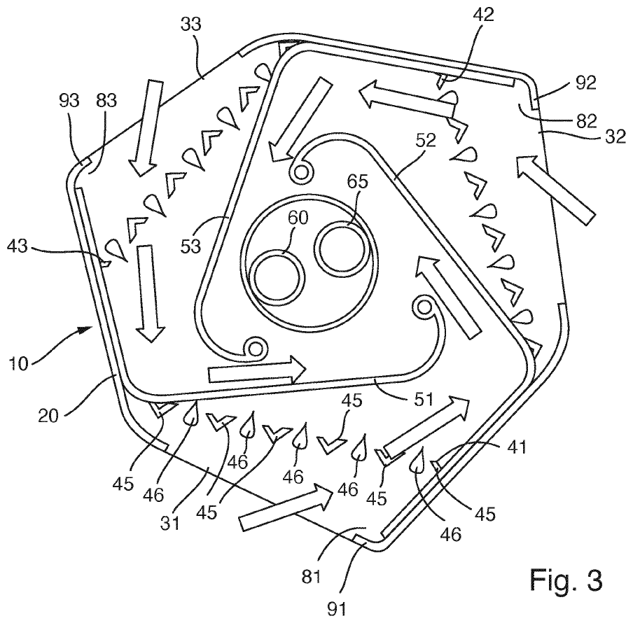

FIG. 3 shows an intake chamber 10 according to a further example. In this case, in addition to the connector 60, a further connector 65 is present which is arranged directly next to said connector. This makes it possible to arrange a module within the intake chamber 10, said module actively generating negative pressure. This will be discussed in more detail further below with reference to FIG. 7.

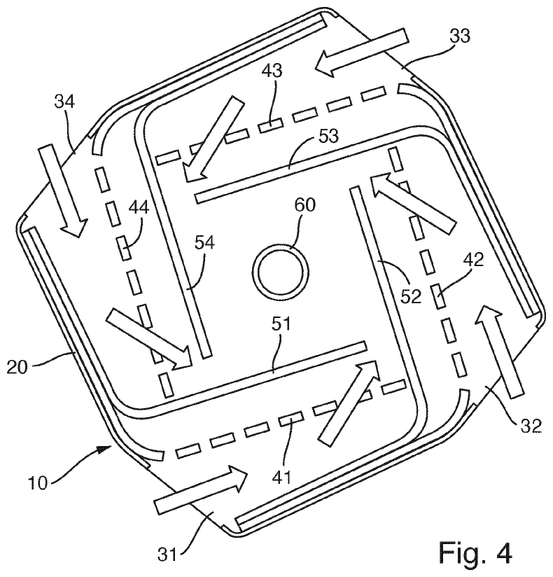

FIG. 4 shows an intake chamber 10 according to a further example. In contrast to the example of FIG. 2, the flow control structures 41, 42, 43 in this case are not embodied with the structure described with reference to FIG. 2, but rather are embodied as interrupted walls which extend along a line. Furthermore, a fourth inlet opening 34 with a fourth flow control structure 44 and a fourth deflecting wall 54 is additionally present. As a result, operating medium can enter at even more points, wherein here, too, a radial symmetry, this time at an angle of 90°, can be seen. Other examples are accordingly also possible.

In this and the further examples, the undercuts are of smaller example; this will therefore not be discussed separately in any more detail.

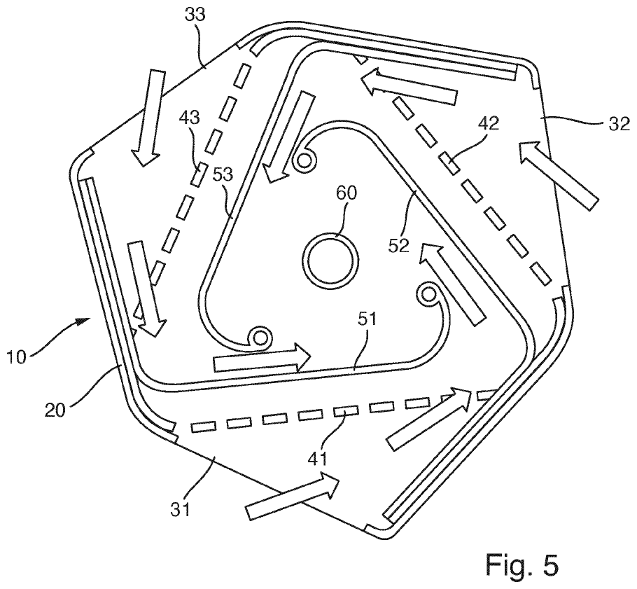

FIG. 5 shows an intake chamber 10 according to a further example. In contrast to the example of FIG. 2, the flow control structures 41, 42, 43 in this case are embodied as interrupted, rectilinear walls, as in the example of FIG. 4. Reference should otherwise be made to the description of FIG. 2.

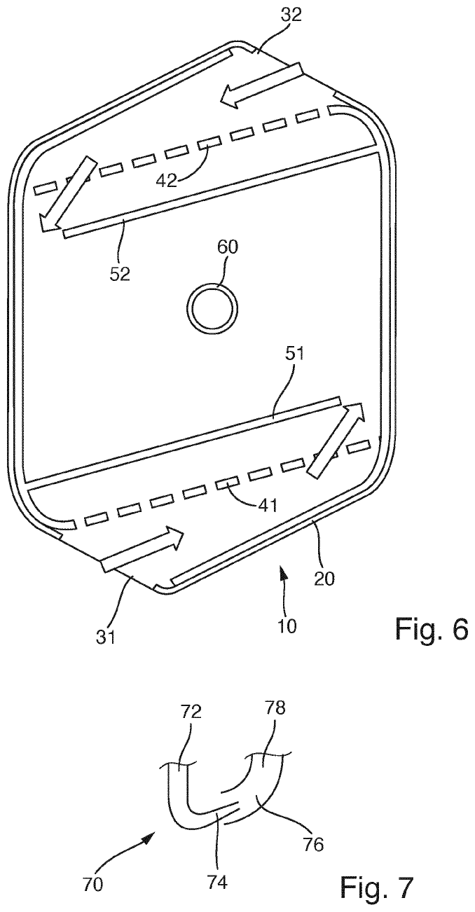

FIG. 6 shows an intake chamber 10 according to a further example. In a deviation from the example of FIG. 5, merely two inlet openings 31, 32 with associated flow control structures 41, 42 and deflecting walls 51, 52 are present in this case. The radial symmetry is formed in this case at an angle of 180°.

FIG. 7 shows, in purely schematic form, a module 70 which can be used for example in an example of FIG. 3 in order to generate a negative pressure within the intake chamber 10. The module 70 comprises an inlet 72 which can be connected, for example, to the further connector 65. The inlet 72 fluidically leads to a motive nozzle 74 which points into a mixing chamber 76. The mixing chamber 76 in turn is fluidically connected to an outlet 78 which can be connected to the connector 60.

If a motive jet is thus delivered through the further connector 65, said jet generates a very rapid flow, which exits from the motive nozzle 74. A negative pressure is generated in the mixing chamber 76. The mixing chamber 76 is open toward the outside, that is to say toward the interior of the housing 20, and therefore ensures that the negative pressure acts within the intake chamber 10. As a result, operating medium can be sucked in and can pass with the backflowing motive jet from the outlet 78 into the connector 60, whence the sucked-in operating medium can be further used.

The module 70 can be embodied independently of the intake chamber 10, with the result that it can be plugged on as required but can also be exchanged separately.

The term module (and other similar terms such as unit, subunit, submodule, etc.) in the present disclosure may refer to a software module, a hardware module, or a combination thereof. Modules implemented by software are stored in memory or non-transitory computer-readable medium. The software modules, which include computer instructions or computer code, stored in the memory or medium can run on a processor or circuitry (e.g., ASIC, PLA, DSP, FPGA, or other integrated circuit) capable of executing computer instructions or computer code. A hardware module may be implemented using one or more processors or circuitry. A processor or circuitry can be used to implement one or more hardware modules. Each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices and stored in memory or non-transitory computer readable medium.

For the sake of legibility, the expression “at least one” has in some cases been omitted for simplicity. Where a feature of the technology described here is described in singular or indefinite terms (e.g. the/an opening, the/a mixing chamber, etc.), this is at the same time also intended to disclose a multiplicity thereof (e.g. the at least one opening, the at least one mixing chamber, etc.).

The above description of the present subject matter serves merely for illustrative purposes and not for the purposes of limiting the present subject matter. In the context of the present subject matter, various alterations and modifications are possible without departing from the scope of the present subject matter and of its equivalents.

### LIST OF REFERENCE DESIGNATIONS

10 Intake chamber
20 Housing
21 Upper side
22 Lower side
31, 32, 33, 34 Inlet openings
41, 42, 43, 44 Flow control structures
45, 46 Flow resistance elements
51, 52, 53, 54 Deflecting walls
60 Connector
65 Further connector
70 Module
72 Inlet
74 Motive nozzle
76 Mixing chamber
78 Outlet
81, 82, 83 Undercuts
91, 92, 93 Projections

1. An intake chamber (10) for an operating medium pump for sucking in operating medium stored in an operating medium vessel of a motor vehicle,
comprising a housing (20), the lower side (22) of which is configured to abut against a bottom of the operating medium vessel and in the upper side (21) of which at least one connector (60) for a line of the operating medium pump is formed,
wherein at least a first inlet opening (31) and a second inlet opening (32) for the inlet of operating medium to the connector (60) are formed laterally in the housing (20),
wherein a deflecting wall (51, 52, 53, 54) is arranged between each inlet opening (31, 32, 33, 34) and each connector (60) in the housing (20), and
wherein an undercut (81, 82) is formed on the inside of at least one inlet opening (31, 32).

2. The intake chamber (10) according to claim 1, wherein an undercut (81, 82, 83) is formed on the inside of some of the inlet openings (31, 32, 33) or all of the inlet openings (31, 32, 33).

3. The intake chamber (10) according to claim 1 or 2, wherein a, some or all of the undercuts (81, 82, 83) are formed by a projection (91, 92, 93) in the housing (20), said projection directly adjoining the inlet opening (31, 32, 33).

4. The intake chamber (10) according to claim 3, wherein a projection (91, 92, 93), some or all of the projections (91, 92, 93) are oriented in a plane with the inlet opening (31, 32, 33).

5. The intake chamber (10) according to claim 3 or 4, wherein a projection (91, 92, 93), some or all of the projections (91, 92, 93) assume an angle of at least 45° and/or an angle of at most 90° with respect to a directly adjoining portion of the housing (20).

6. The intake chamber (10) according to one of the preceding claims, wherein at least a third inlet opening (33) for the inlet of operating medium to the connector (60) is formed laterally in the housing (20).

7. The intake chamber (10) according to claim 6, wherein at least a fourth inlet opening (34) for the inlet of operating medium to the connector (60) is formed laterally in the housing (20).

8. The intake chamber (10) according to one of the preceding claims, wherein the inlet openings (31, 32, 33, 34) are formed in an elongate manner on side surfaces of the housing (20).

9. The intake chamber (10) according to one of the preceding claims, wherein the inlet openings (31, 32, 33, 34) have identical angular spacings to respective peripherally adjacent inlet openings (31, 32, 33, 34).

10. The intake chamber (10) according to one of the preceding claims, wherein the inlet openings (31, 32, 33, 34) and/or the deflecting walls are invariant in relation to rotations by angles which are 360° divided by the number of inlet openings (31, 32, 33, 34) or an integer multiple thereof.

11. The intake chamber (10) according to one of the preceding claims, wherein the deflecting walls (51, 52, 53, 54) and/or other constituent parts of the housing (20) form a respective channel from the inlet openings (31, 32, 33, 34) toward the connector (60), said channel having, at least along a portion, a cross section which decreases toward the connector (60).

12. The intake chamber (10) according to one of the preceding claims, wherein a further connector (65) is formed in the upper side (21) of the housing (20) and is arranged directly adjacent to the connector (60).

13. The intake chamber (10) according to claim 12,
wherein a motive nozzle (74) and a mixing chamber (76) are arranged in the housing (20),
wherein the motive nozzle (74) is directed at the mixing chamber (76) and is connected on the input side to the further connector (65), and
wherein the mixing chamber (76) is connected on the output side to the connector (60) and comprises an opening to the interior of the housing (20).

14. The intake chamber (10) according to claim 13, wherein the motive nozzle (74) and the mixing chamber (76) are arranged in a module (70) which can be removed from the housing (20).

15. The intake chamber (10) according to one of the preceding claims, wherein a flow control structure (41, 42, 43, 44) is arranged at the inlet openings (31, 32, 33, 34), at the outside in relation to the respective deflecting wall (51, 52, 53, 54), and extends along a respective line.

16. The intake chamber (10) according to claim 15, wherein the flow control structure (41, 42, 43, 44) comprises a plurality of first flow resistance elements (45) and a plurality of second flow resistance elements (46), which are arranged in an alternating manner along the respective line, wherein the first flow resistance elements (45) are of tapered form in an outflow direction and the second flow resistance elements (46) are of droplet-like form in cross section, wherein a tip of the droplet points toward the interior of the housing (20); or wherein a flow control structure (41, 42, 43, 44) is embodied as an interrupted wall along the line.

17. The intake chamber (10) according to one of the preceding claims, wherein the connector (60) is in the form of an opening through which a line is plugged, and/or wherein the further connector (65) is in the form of an opening through which a line is plugged.

18. The intake chamber (10) according to one of the preceding claims, wherein the connector (60) is in the form of a line protruding into the housing (20), and/or wherein the further connector (65) is in the form of a line protruding into the housing (20).

19. The intake chamber (10) according to one of the preceding claims, wherein the lower side (22) of the housing (20) lies in a plane.

20. The intake chamber (10) according to one of the preceding claims, wherein the intake chamber (10) is completely closed on the upper side (21) outside of the connector (60) and/or of the further connector (65).

21. A suction jet pump or operating medium pump, comprising at least one electrical pump unit and at least one intake chamber (10) according to one of the preceding claims, wherein the connector (60) or further connector (65) of the intake chamber (10) is fluidically connected to the pump unit.
